(19) United States
(12) Patent Application Publication
(10) Pub. No.: US 2026/0208653 A1
(43) Pub. Date: Jul. 23, 2026

(54) APPARATUS OF DELIVERING CONSIGNMENT

(71) Applicants: Hyundai Motor Company, Seoul (KR); Kia Corporation, Seoul (KR)

(72) Inventors: Kyungwook Lee, Hwaseong-si (KR); Junhwan Park, Hwaseong-si (KR); Pankeun Baek, Hwaseong-si (KR)

(21) Appl. No.: 19/220,691

(22) Filed: May 28, 2025

(30) Foreign Application Priority Data
Jan. 21, 2025 (KR) 10-2025-0008798

(51) Int. Cl. B60P 1/43

(52) U.S. Cl. CPC B60P 1/433

(57) ABSTRACT

An apparatus of delivering a consignment can include a housing, a delivery unit mounted in the housing to be movable in the length direction between a retracted state and a deployed state, and including support rollers disposed to be rotatable, and a conveyor belt extending across the support rollers and rotatable between the support rollers at both sides in the length direction by rotation of at least one of the support rollers; a driving unit configured to provide power to the delivery unit to move the delivery unit in the length direction between the retracted state and the deployed state, and to provide power to at least one of the support rollers to rotate the at least one support roller, such that the consignment can be disposed on the conveyor belt and delivered to a target delivery point by rotation of the conveyor belt in one direction.

### CROSS-REFERENCE TO RELATED APPLICATIONS

This application claims priority to and the benefit of Korean Patent Application No. 10-2025-0008798 filed with the Korean Intellectual Property Office on January 21, 2025, the entire contents of which are incorporated herein by reference.

### TECHNICAL FIELD

The present disclosure relates to an apparatus of delivering a consignment.

### BACKGROUND

Due to development of the Internet and rise of online shopping, the trend of purchasing goods online is increasing. The goods purchased online in this way may be delivered to buyers through courier services, and tens of thousands of couriers across the country work on-site to deliver these goods on time.

In particular, a courier may load a consignment onto a vehicle and travel the same along a road to a vicinity of a delivery location. Upon arriving at the delivery location, the courier may unload the consignment from the vehicle and transport the same directly to the delivery location. Accordingly, delivery time may increase and delivery workload may become excessive.

Such a delivery difficulty may occur because the vehicle is unable to travel directly across the road to the delivery location. This delivery difficulty may be overcome if a delivery apparatus may be deployed from a vehicle on the road in the vicinity of the delivery location and transport the consignment to a delivery location, thereby automatically delivering the consignment to the delivery location.

The above information disclosed in this Background section is provided only to assist in a better understanding of the background of the present disclosure, and may therefore include information that is not a part of the prior art already publicly known, available, or in use.

### SUMMARY

The present disclosure relates to an apparatus of delivering a consignment, and more particularly, to an apparatus of delivering a consignment that delivers the consignment by deploying a delivery unit from a housing mounted in a vehicle or the like and transporting the consignment to a target delivery point.

An embodiment of the present disclosure can provide an apparatus of delivering a consignment that automatically delivers the consignment to a target delivery point by deploying a delivery unit from a housing mounted in a vehicle or the like and transporting the consignment to the target delivery point.

According to an embodiment, an apparatus of delivering a consignment can include: a housing forming a mounting space by having a length from one side to the other side in a length direction, a width from one side to the other side in a width direction perpendicular to the length direction, and a height in a height direction perpendicular to the length direction and the width direction, at least a portion of the other side of the housing being open in the length direction; a delivery unit mounted in the housing to be movable in the length direction between a retracted state and a deployed state, and including a plurality of support rollers disposed to be rotatable about the width direction, and a conveyor belt extending across the plurality of support rollers and rotatable between the support rollers at both sides in the length direction by rotation of at least one of the plurality of support rollers; and a driving unit configured to provide power to the delivery unit to move the delivery unit in the length direction between the retracted state and the deployed state, and to provide power to at least one of the plurality of support rollers to rotate the at least one support roller, wherein the consignment is disposed on the conveyor belt and delivered to a target delivery point by rotation of the conveyor belt in one direction.

First and second rails may be mounted on both sides of the housing in the width direction, the first and second rails extending in the length direction, and the delivery unit may further include first and second support plates disposed on both sides of the delivery unit in the width direction, at least one first guide disposed on an outer surface of the first support plate facing the first rail and having a groove corresponding to the first rail, and at least one second guide disposed on an outer surface of the second support plate facing the second rail and having a groove corresponding to the second rail, the first rail being coupled to the groove of the first guide to be movable in the length direction, and the second rail being coupled to the groove of the second guide to be movable in the length direction.

The plurality of support rollers may be rotatably connected to the first and second support plates.

The driving unit may include a power source including a power source shaft rotatable in both directions and providing the power, a power source driving unit configured to provide the power by being fixedly mounted on and rotating together with the power source shaft, a conveyor rotary portion operably connected to the power source driving unit through a power source output transmission member and fixedly mounted on a conveyor driving shaft, a first one-way power transmission member mounted on the conveyor driving shaft, operably connected to the conveyor driving shaft when the conveyor driving shaft rotates in the one direction, and freely rotatable when the conveyor driving shaft rotates in a direction opposite to the one direction, a second one-way power transmission member mounted on the conveyor driving shaft, operably connected to the conveyor driving shaft when the conveyor driving shaft rotates in the direction opposite to the one direction, and freely rotatable when the conveyor driving shaft rotates in the one direction, a first rack portion fixedly mounted on the delivery unit and engaged with the first one-way power transmission member to receive the power from the first one-way power transmission member and move to the other side in the length direction when the conveyor driving shaft rotates in the one direction, and a second rack portion fixedly mounted on the delivery unit and engaged with the second one-way power transmission member to receive the power from the second one-way power transmission member and move to the one side in the length direction when the conveyor driving shaft rotates in the direction opposite to the one direction.

A length of the first rack portion may be shorter than a length of the second rack portion.

The driving unit may further include a conveyor belt driving unit fixedly mounted on the conveyor driving shaft and rotating together with the conveyor driving shaft; and a conveyor belt driven unit fixedly mounted on a conveyor driven shaft to rotate together with the conveyor driven shaft, and selectively coupled to the conveyor belt driving unit depending on whether the first rack portion and the first one-way power transmission member are coupled to each other.

When the first rack portion moves to the other side in the length direction and is separated from the first one-way power transmission member, the conveyor belt driven unit may be coupled to the conveyor belt driving unit.

When the conveyor driving shaft rotates in the one direction and the first rack portion is separated from the first one-way power transmission member, the conveyor belt driven unit may be operably connected to the conveyor belt driving unit to rotate in the one direction.

The conveyor driven shaft may be fixedly mounted on one of the plurality of support rollers.

The apparatus may further include a brake device fixedly mounted on the conveyor driven shaft and configured to prevent a rotation of the conveyor driven shaft caused by a load of the consignment and to be rotatable by the power from the power source.

The plurality of support rollers may include a plurality of first and second support rollers, and the conveyor belt may include a first conveyor belt extending across the plurality of first support rollers and a second conveyor belt extending across the plurality of second support rollers.

First and second rails may be mounted on both sides of the housing in the width direction and extend in the length direction.

The delivery unit may further include a pair of first support plates disposed on the one side and a center portion in the width direction and extending in the length direction, a pair of second support plate disposed on the other side and the center portion in the width direction and extending in the length direction, at least one first guide disposed on an outer surface of one of the pair of first support plates facing the first rail and having a groove corresponding to the first rail, and at least one second guide disposed on an outer surface of one of the pair of second support plates facing the second rail and having a groove corresponding to the second rail.

The first rail can be coupled to the groove of the first guide to be movable in the length direction, and the second rail can be coupled to the groove of the second guide to be movable in the length direction.

The plurality of first support rollers may be rotatably connected to the pair of first support plates, and the plurality of second support rollers may be rotatably connected to the pair of second support plates.

The driving unit may include a power source including a power source shaft rotatable in both directions and providing the power, a power source driving unit configured to provide the power by being fixedly mounted on and rotating together with the power source shaft, a conveyor rotary portion operably connected to the power source driving unit through a power source output transmission member and fixedly mounted on a conveyor driving shaft, a first one-way power transmission member mounted on the conveyor driving shaft, operably connected to the conveyor driving shaft when the conveyor driving shaft rotates in the one direction, and freely rotatable when the conveyor driving shaft rotates in a direction opposite to the one direction, a second one-way power transmission member mounted on the conveyor driving shaft, operably connected to the conveyor driving shaft when the conveyor driving shaft rotates in the direction opposite to the one direction, and freely rotatable when the conveyor driving shaft rotates in the one direction, a first rack portion fixedly mounted on the delivery unit and engaged with the first one-way power transmission member to receive the power from the first one-way power transmission member and move to the other side in the length direction when the conveyor driving shaft rotates in the one direction, and a second rack portion fixedly mounted on the delivery unit and engaged with the second one-way power transmission member to receive the power from the second one-way power transmission member and move to the one side in the length direction when the conveyor driving shaft rotates in the direction opposite to the one direction.

A length of the first rack portion may be shorter than a length of the second rack portion.

The driving unit may further include a conveyor belt driving unit fixedly mounted on the conveyor driving shaft and rotating together with the conveyor driving shaft, and a conveyor belt driven unit fixedly mounted on a conveyor driven shaft to rotate together with the conveyor driven shaft, and selectively coupled to the conveyor belt driving unit depending on whether the first rack portion and the first one-way power transmission member are coupled to each other.

When the first rack portion moves to the other side in the length direction and is separated from the first one-way power transmission member, the conveyor belt driven unit may be coupled to the conveyor belt driving unit.

When the conveyor driving shaft rotates in the one direction and the first rack portion is separated from the first one-way power transmission member, the conveyor belt driven unit may be operably connected to the conveyor belt driving unit to rotate in the one direction.

The conveyor driven shaft may be fixedly mounted on one of the plurality of first support rollers and one of the plurality of second support rollers.

The apparatus may further include a brake device fixedly mounted on the conveyor driven shaft and configured to prevent a rotation of the conveyor driven shaft caused by a load of the consignment and to be rotatable by the power from the power source.

The brake device may include a plurality of shaft holders surrounding an outer peripheral surface of the conveyor driven shaft and coupled to each other to fixedly mount the brake device on the conveyor driven shaft, and a pair of pin holders respectively coupled to both surfaces of the plurality of shaft holders, each having a size larger than a size of the shaft holders in a coupled state, and each having a polygonal shape.

The brake device may further include at least one pin mounted rotatably at each vertex of the pair of pin holders.

As set forth above, according to an embodiment of the present disclosure, the delivery unit may be deployed from the housing mounted in the vehicle or the like to the target delivery point, and the consignment may thus be automatically delivered to the target delivery point. Therefore, the delivery time and the delivery workload may be reduced.

In an embodiment of the present disclosure, the minimum power source may be used to make the delivery of the delivery unit, the rotation of the conveyor belt, and the retraction of the delivery unit possible.

In an embodiment of the present disclosure, the rotation of the conveyor belt caused by the load of the consignment may be prevented not only while the delivery apparatus is disposed horizontally but also while the delivery apparatus is inclined.

Advantages that may be acquired or predicted from the example embodiments of the present disclosure are disclosed directly or implicitly in the detailed description of the example embodiments of the present disclosure.

### BRIEF DESCRIPTION OF THE DRAWINGS

Example embodiments in the specification may be better understood by reference to the following description in connection with the accompanying drawings in which like reference numerals can refer to identical or functionally similar elements.

FIG. 1 is a perspective view of an apparatus of delivering a consignment according to an embodiment of the present disclosure, and schematically shows a state in which a delivery unit is retracted.

FIG. 2 is a perspective view of an apparatus of delivering a consignment according to an embodiment of the present disclosure, and schematically shows a state in which a delivery unit is deployed.

FIG. 3 is a schematic perspective view of a delivery unit and a driving unit included in an apparatus of delivering a consignment according to an embodiment of the present disclosure.

FIG. 4 is a schematic perspective view of a delivery unit and a driving unit according to an embodiment of the present disclosure, without first and second conveyor belts.

FIG. 5 is a schematic plan view of an apparatus of delivering a consignment according to an embodiment of the present disclosure.

FIG. 6 is a schematic view showing a portion of a driving unit of an apparatus of delivering a consignment according to an embodiment of the present disclosure.

FIG. 7 schematically shows a state in which an apparatus of delivering a consignment according to an embodiment of the present disclosure starts delivering a consignment.

FIG. 8 schematically shows a state in which first and second conveyor belts of an apparatus of delivering a consignment according to an embodiment of the present disclosure rotate and deliver a consignment.

FIG. 9 schematically shows a state in which an apparatus of delivering a consignment according to an embodiment of the present disclosure starts retraction.

FIG. 10 is a schematic view showing a brake device of an apparatus of delivering a consignment according to an embodiment of the present disclosure.

FIG. 11 is an exploded view of a brake device of an apparatus of delivering a consignment according to an embodiment of the present disclosure.

It can be understood that the drawings referenced above are not necessarily drawn to scale, and can present a rather simplified representation of various features illustrating basic principles of some example embodiments of the present disclosure. For example, specific design features of an embodiment of the present disclosure, including a specific dimension, orientation, position and shape, can be determined in part by the particular intended application and environment of use.

### DETAILED DESCRIPTION OF ILLUSTRATIVE EMBODIMENTS

Terms used herein are to describe example embodiments of the present disclosure, and are not intended to necessarily limit the present disclosure. A term of a single number used herein can be intended to include its plural number, unless the context clearly indicates otherwise. It can be understood that the terms "include" and/or "including", when used in the specification, specify the presence of the recited features, integers, steps, operations, elements, and/or components, and do not exclude the presence or addition of one or more of other features, integers, steps, operations, elements, elements, components, and/or groups thereof. The term "and/or" used herein includes any one or all combinations of the associated listed items.

A term "vehicle", "of a/the vehicle", or other similar terms used in this specification may include general automobiles such as passenger vehicles, buses, trucks, and various commercial vehicles, which include sport utility vehicles (SUVs), ships including various boats and vessels, aircraft, tractors, drones, and robots, and may also include any object that may be moved by receiving power from a power source, for example. A "vehicle" or other similar terms used in this specification may be understood to include a hybrid powered vehicle, an electric powered vehicle, a plug-in hybrid powered vehicle, a hydrogen powered vehicle, and another alternative fuel (e.g., fuel derived from a source other than petroleum) powered vehicle, for example. As mentioned herein, a hybrid powered vehicle may include a vehicle that has two or more power sources, for example, a gasoline powered vehicle or an electric powered vehicle. A vehicle according to an embodiment of the present disclosure may include a vehicle that drives partially autonomously as well as a vehicle that drives fully autonomously or automatically, for example.

In this specification, the terms "operably coupled", "operably connected", or similar terms may indicate that two members are coupled or connected to each other to transmit and receive power.

It can be understood that one or more of methods described below or operations thereof may be executed by at least one controller. The term "controller" may refer to a hardware device including at least one memory and at least one processor. A memory may store program instructions, and a processor may be specifically programmed to execute such program instructions to perform one or more processes described below in more detail. A controller may control operations of units, modules, components, devices, or the like, as described herein. It can be understood that at least some of the methods described below may be executed by an apparatus including a controller in conjunction with one or more other components, as can be appreciated by those skilled in the art.

A controller of an embodiment of the present disclosure may be implemented as at least one non-transitory computer-readable recording medium including executable program instructions executed by at least one processor. An example of the computer-readable recording medium may include a read only memory (ROM), a random access memory (RAM), a compact disk read only memory (CD-ROM), a magnetic tape, a floppy disk, a flash drive, a smart card, or an optical data storage device, and is not necessarily limited thereto, for example. A computer-readable recording medium may be distributed throughout a computer network, and the program instructions may thus be stored and executed in a distributed manner, for example, on a telematics server or a controller area network (CAN).

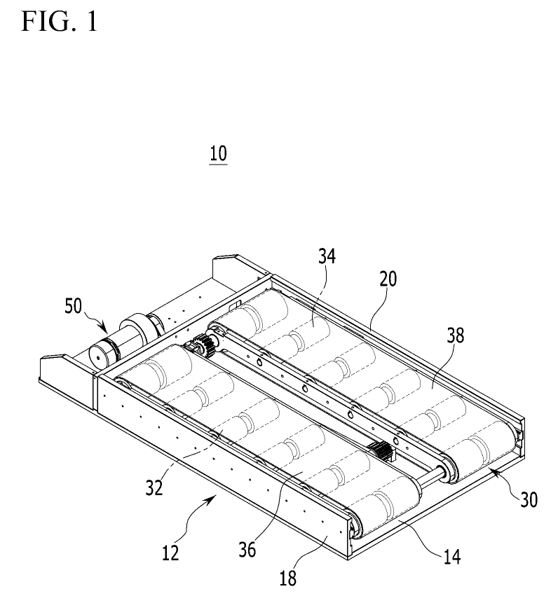

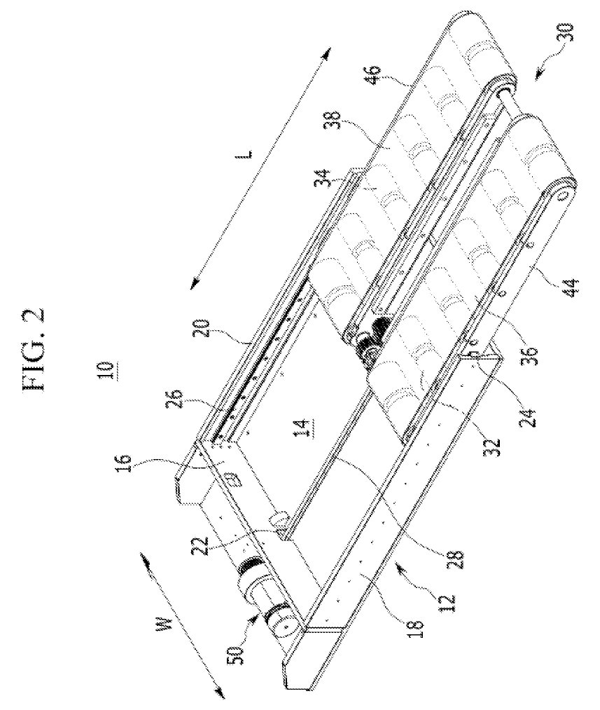

FIG. 1 is a perspective view of an apparatus of delivering a consignment according to an embodiment of the present disclosure, and schematically shows a state in which a delivery unit is retracted. FIG. 2 is a perspective view of an apparatus of delivering a consignment according to an embodiment of the present disclosure, and schematically shows a state in which a delivery unit is deployed.

As shown in FIGS. 1 and 2, an apparatus 10 of delivering a consignment according to an embodiment of the present disclosure may be mounted in a vehicle or a movable robot and may be retracted into the vehicle or the movable robot (see FIG. 1) or deployed from the vehicle or the movable robot (see FIG. 2). Either a single apparatus 10 of delivering a consignment or a plurality of apparatuses 10 of delivering a consignment may be mounted in a vehicle or a movable robot. The apparatus 10 of delivering the consignment may include a housing 12, a delivery unit 30, and a driving unit.

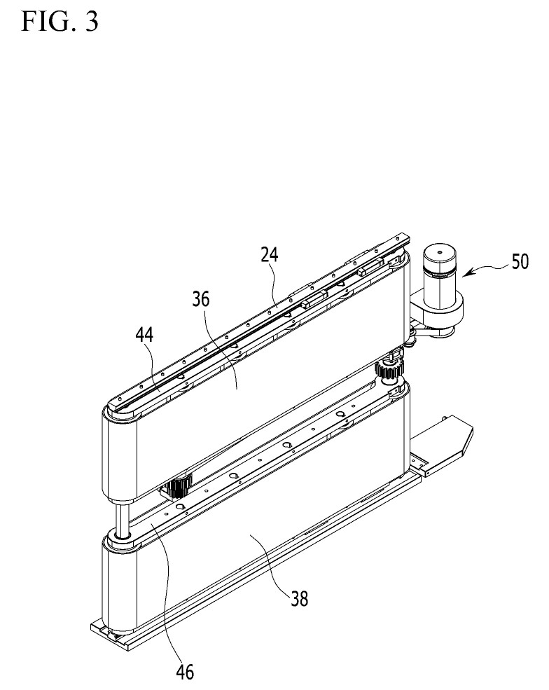

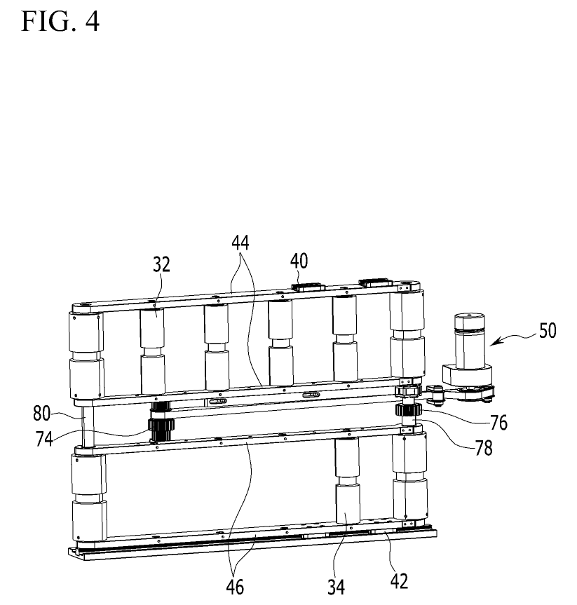

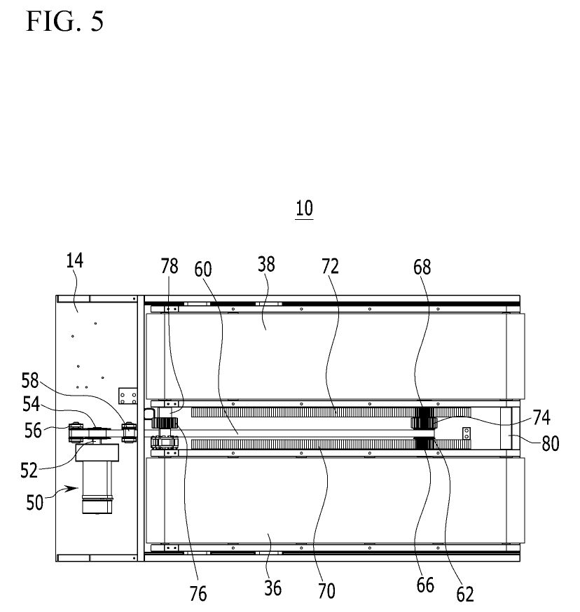

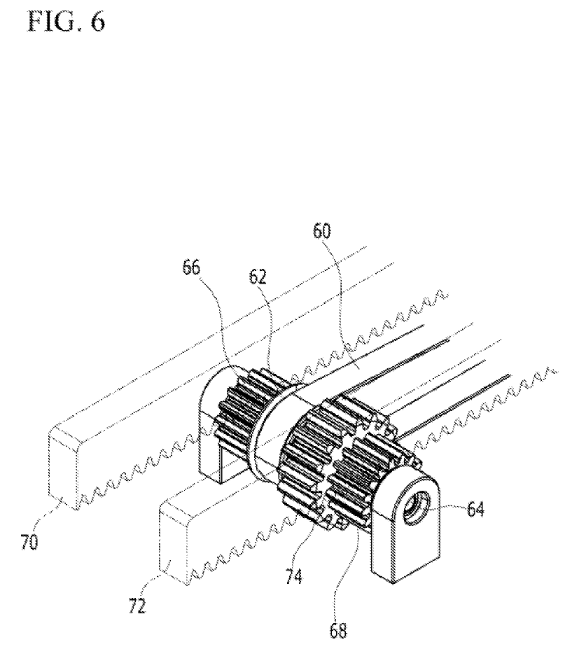

FIG. 3 is a schematic perspective view of a delivery unit and a driving unit included in an apparatus of delivering a consignment according to an embodiment of the present disclosure. FIG. 4 is a schematic perspective view of a delivery unit and a driving unit according to an embodiment of the present disclosure, without first and second conveyor belts. FIG. 5 is a schematic plan view of an apparatus of delivering a consignment according to an embodiment of the present disclosure. FIG. 6 is a schematic view showing a portion of a driving unit of an apparatus of delivering a consignment according to an embodiment of the present disclosure.

As shown in FIGS. 1 to 6, the housing 12 may be mounted at an appropriate position in a vehicle or a movable robot (e.g., a trunk floor surface, a truck bed, or the like of a vehicle), and the delivery unit 30 and the driving unit may be mounted in the housing 12. The housing 12 may have a generally rectangular hexahedron shape having an open top surface, and may not be necessarily limited thereto. As an example, the housing 12 may have a width in a width direction W, a length in a length direction L, and a height in a height direction to form a generally rectangular hexahedron mounting space, and have the open top surface. The housing 12 may include a base 14 and first, second, and third walls 16, 18, and 20.

The base 14 can provide a floor surface of the housing 12 and may be fixedly mounted at any appropriate position in a vehicle or a movable robot (e.g., a trunk floor surface, a truck bed, or the like of a vehicle). The base 14 may have a generally flat plate shape not to impede a movement of the delivery unit 30. The first, second, and third walls 16, 18, and 20 can each have a certain, selected, or predetermined height and may be mounted in a rectangular shape with one side open on the base 14.

The first wall 16 may be mounted on one side of the base 14 in the length direction L and may extend in the width direction W. A through hole 22 may be formed in a center portion of the first wall 16 in the width direction W.

The second wall 18 may be mounted on one side of the base 14 in the width direction W. One end of the second wall 18 in the length direction L may be connected to one end of the first wall 16 in the width direction W, and the second wall 18 may extend to the other side in the length direction L. A first rail 24 may be mounted on an inner surface of the second wall 18 (i.e., one surface facing the third wall 20), and the first rail 24 may extend in the length direction L to guide the movement of the delivery unit 30 in the length direction.

The third wall 20 may be mounted on the other side of the base 14 in the width direction W. One end of the third wall 20 in the length direction L may be connected to the other end of the first wall 16 in the width direction W, and the third wall 20 may extend to the other side in the length direction L. A second rail 26 may be mounted on an inner surface of the third wall 20 (i.e., one surface facing the second wall 18), and the second rail 26 may extend in the length direction L to guide the movement of the delivery unit 30 in the length direction.

The other side of the housing 12 in the length direction L may be open, and the delivery unit 30 may be deployed or retracted in the length direction L through the opening. That is, the delivery unit 30 may be mounted in the housing 12 to be movable in the length direction L between a retracted state and a deployed state.

As an example, the delivery unit 30 may include a pair of first support plates 44, a pair of second support plates 46, a plurality of first support rollers 32, a plurality of second support rollers 34, and first and second conveyor belts 36 and 38.

The pair of first support plates 44 may be disposed to be parallel to each other and extend in the length direction L. One of the pair of first support plates 44 may be disposed on one side of the delivery unit 30 in the width direction W, and the other of the pair of first support plates 44 may be disposed on a center portion of the delivery unit 30 in the width direction W. At least one first guide 40 may be provided on an outer surface of the one of the pair of first support plates 44 facing the first rail 24 and a groove can be formed on an outer surface of the at least one first guide 40 facing the first rail 24 to thus allow the first rail 24 to be inserted into the groove of the at least one first guide 40, thereby guiding a sliding movement of the delivery unit 30 in the length direction L.

The pair of second support plates 46 may be disposed to be parallel to each other and extend in the length direction L. One of the pair of second support plates 46 may be disposed on the other side of the delivery unit 30 in the width direction W, and the other of the pair of second support plates 46 may be disposed on the center portion of the delivery unit 30 in the width direction W. At least one second guide 42 may be provided on an outer surface of the one of the pair of second support plates 46 facing the second rail 26 and a groove can be formed on an outer surface of the at least one second guide 42 facing the second rail 26 to thus allow the second rail 26 to be inserted into the groove of the at least one second guide 42, thereby guiding the sliding movement of the delivery unit 30 in the length direction L.

The plurality of first support rollers 32 may be disposed between the pair of first support plates 44, and each of the first support rollers 32 may thus be rotatably connected to the pair of first support plates 44. One of the neighboring first support rollers 32 may be disposed apart from in the length direction and parallel with the other of the neighboring first support rollers 32. Accordingly, each of the first support rollers 32 may be rotatable about the width direction W.

The plurality of second support rollers 34 may be disposed between the pair of second support plates 46, and each of the second support rollers 34 may be rotatably connected to the pair of first support plates 46. One of the neighboring second support rollers 34 may be disposed apart from in the length direction and parallel with the other of the neighboring second support rollers 34. Accordingly, each of the second support rollers 34 may be rotatable about the width direction W.

The first conveyor belt 36 may extend across the plurality of first support rollers 32 and may be movable in the length direction L together with the delivery unit 30. The first conveyor belt 36 may be rotatable between the first support roller 32 at one farthest side in the length direction L and the first support roller 32 at the other farthest side in the length direction L among the plurality of first support rollers 32 by rotation of at least one of the plurality of first support rollers 32. In more detail, when the plurality of first support rollers 32 does not rotate, the first conveyor belt 36 may move in the length direction L together with the delivery unit 30 in a non-rotating state. When the first support roller 32 at the one farthest side in the length direction L and the first support roller 32 at the other farthest side in the length direction L rotate in one direction, a top portion of the first conveyor belt 36 may move to the other side in the length direction L and a bottom portion of the first conveyor belt 36 may move to the one side in the length direction L. Accordingly, when the first support roller 32 at the one farthest side in the length direction L and the first support roller 32 at the other farthest side in the length direction L rotate in the one direction, the consignment disposed on the first conveyor belt 36 may be moved to the other side in the length direction L and delivered. In contrast, when the first support roller 32 at the one farthest side in the length direction L and the first support roller 32 at the other farthest side in the length direction L rotate in a direction opposite to the one direction, the top portion of the first conveyor belt 36 may move to the one side in the length direction L, and the bottom portion of the first conveyor belt 36 may move to the other side in the length direction L.

The second conveyor belt 38 may extend across the plurality of second support rollers 34 and may be movable in the length direction L together with the delivery unit 30. The second conveyor belt 38 may rotate between the second support roller 34 at one farthest side in the length direction L and the second support roller 34 at the other farthest side in the length direction L among the plurality of second support rollers 34 by rotation of at least one of the plurality of second support rollers 34. In more detail, when the plurality of second support rollers 34 does not rotate, the second conveyor belt 38 may move in the length direction L together with the delivery unit 30 in a non-rotating state. When the second support roller 34 at the one farthest side in the length direction L and the second support roller 34 at the other farthest side in the length direction L rotate in one direction, a top portion of the second conveyor belt 38 may move to the other side in the length direction L and a bottom portion of the second conveyor belt 38 may move to the one side in the length direction L. Accordingly, if the second support roller 34 at the one farthest side in the length direction L and the second support roller 34 at the other farthest side in the length direction L rotate in the one direction, the consignment disposed on the second conveyor belt 38 may be moved to the other side in the length direction L and delivered. In contrast, when the second support roller 34 at the one farthest side in the length direction L and the second support roller 34 at the other farthest side in the length direction L rotate in the direction opposite to one direction, the top portion of the second conveyor belt 38 may move to the one side in the length direction L and the bottom portion of the second conveyor belt 38 may move to the other side in the length direction L.

As another example, the delivery unit 30 may include the first and second support plates 44 and 46, the plurality of support rollers, and the conveyor belt. In the delivery unit 30 according to another example, the first and second support rollers 32 and 34 disposed parallel to each other may be integrated into a corresponding support roller and the first and second conveyor belts 36 and 38 may be integrated into one conveyor belt.

The first support plate 44 may be disposed on the one side of the delivery unit 30 in the width direction W and may extend in the length direction L. At least one first guide 40 may be disposed on the outer surface of the first support plate 44 facing the first rail 24, and the groove may be formed in the outer surface of the at least one first guide 40 facing the first rail 24 to thus allow the first rail 24 to be inserted into the groove of the at least one first guide 40, thereby guiding the movement of the delivery unit 30 in the length direction L.

The second support plate 46 may be disposed on the other side of the delivery unit 30 in the width direction W and may extend in the length direction L. At least one second guide 42 may be disposed on the outer surface of the second support plate 46 facing the second rail 26, and the groove may be formed in the outer surface of the at least one second guide 42 facing the second rail 26 to thus allow the second rail 26 to be inserted into the groove of the at least one second guide 42, thereby guiding the movement of the delivery unit 30 in the length direction L.

The plurality of support rollers may be disposed between the first and second support plates 44 and 46, and the support rollers may thus be rotatably connected to the first and second support plates 44 and 46, respectively. One of the neighboring support rollers may be disposed apart from in the length direction and parallel to the other of the neighboring support rollers. Accordingly, each of the support rollers may be rotatable about the width direction W.

The conveyor belt may extend across the plurality of support rollers and may move in the length direction L together with the delivery unit 30. The conveyor belt may rotate between the support roller at one farthest side in the length direction L and the support roller at the other farthest side in the length direction L among the plurality of support rollers by rotation of at least one of the plurality of support rollers. In more detail, when the plurality of support rollers does not rotate, the conveyor belt may move in the length direction L together with the delivery unit 30 in a non-rotating state. When the support roller at the one farthest side in the length direction L and the support roller at the other farthest side in the length direction L rotate in the one direction, a top portion of the conveyor belt may move to the other side in the length direction L and a bottom portion of the conveyor belt may move to the one side in the length direction L. Accordingly, if the support roller at the one farthest side in the length direction L and the support roller at the other farthest side in the length direction L rotate in the one direction, the consignment disposed on the conveyor belt may be moved to the other side in the length direction L and delivered. When the support roller at the one farthest side in the length direction L and the support roller at the other farthest side in the length direction L rotate in the direction opposite to the one direction, the top portion of the conveyor belt may move to the one side in the length direction L and the bottom portion of the conveyor belt may move to the other side in the length direction L.

As shown in FIGS. 1 to 6, the driving unit may be configured to provide power to the delivery unit 30 to move the delivery unit 30 in the length direction L between a retracted state and a deployed state. The driving unit may be configured to provide the conveyor belt with the power to rotate the conveyor belt of the delivery unit 30 (e.g., the first and second conveyor belts 36 and 38). To this end, the driving unit may include a power source 50, a power source driving unit 54, a conveyor rotary portion 62, first and second one-way power transmission members 66 and 68, first and second rack portions 70 and 72, a conveyor belt driving unit 74, and a conveyor belt driven unit 76.

The power source 50 may provide the power to the delivery unit 30 to move the delivery unit 30 in the length direction L and rotate the conveyor belt (e.g., the first and second conveyor belts 36 and 38). The power source 50 may be mounted on the base 14. As an example, the power source 50 may be mounted on the base 14 at one side from the first wall 16 in the length direction L, and a position of the power source 50 may not be necessarily limited thereto. The power source 50 may be an electric motor that receives current and rotates a power source shaft 52, and a type of the power source 50 may not be necessarily limited thereto. As an example, the power source 50 may be a rotary shaft connected to a handle, and a user may hold the handle and rotate the rotary shaft to provide the power to the delivery unit 30. As another example, the power source 50 may be a hydraulic or pneumatic pump or the like, and may provide hydraulic or pneumatic power to the delivery unit 30. The power source 50 may be rotatable in both directions.

The power source 50 may transmit the power to the power source driving unit 54 fixedly mounted on the power source shaft 52 by rotating the power source shaft 52. The power source driving unit 54 may rotate together with the power source shaft 52 and transmit the power of the power source 50 to the delivery unit 30, particularly to the conveyor rotary portion 62, through a power source output transmission member 60. The power source driving unit 54 may be mounted on the base 14 at one side from the first wall 16 in the length direction L, and the power source output transmission member 60 may extend to the other side in the length direction L through the through hole 22 formed in the first wall 16. However, a position of the power source driving unit 54 and an arrangement of the power source output transmission member 60 are not necessarily limited thereto. In this specification, the power source driving unit 54 and the conveyor rotary portion 62 are exemplified as pulleys, and the power source output transmission member 60 is exemplified as a belt. However, the power source driving unit 54 or the conveyor rotary portion 62 and the power source output transmission member 60 are not necessarily limited to the pulley and the belt, respectively. For example, the power source driving unit 54 and the conveyor rotary portion 62 may be gears and the power source output transmission member 60 may be a chain.

The conveyor rotary portion 62 may rotate by receiving the power from the power source 50 through the power source output transmission member 60. The conveyor rotary portion 62 may be fixedly mounted on a conveyor driving shaft 64 and may rotate together with the conveyor drive shaft 64. In more detail, the conveyor driving shaft 64 may be rotatably mounted on the other side of the base 14 in the length direction L and on a center portion of the base 14 in the width direction W, and the conveyor rotary portion 62 may be fixedly mounted on the conveyor driving shaft 64 and may be operably connected to the power source output transmission member 60. Accordingly, the conveyor rotary portion 62 may be operably connected to the power source driving unit 54 through the power source output transmission member 60 to thus receive the power, thereby rotating about the conveyor driving shaft 64.

The first and second one-way power transmission members 66 and 68 may be mounted on the conveyor driving shaft 64 and may be operably and selectively connected to the conveyor driving shaft 64 depending on rotation direction of the conveyor driving shaft 64. In more detail, the first one-way power transmission member 66 may be mounted on the conveyor driving shaft 64, and operably connected to the conveyor driving shaft 64 when the conveyor driving shaft 64 rotates in the one direction, thereby receiving the power from the conveyor driving shaft 64. The first one-way power transmission member 66 may freely rotate while not being operably connected to the conveyor driving shaft 64 when the conveyor driving shaft 64 rotates in the direction opposite to the one direction. The second one-way power transmission member 68 may be mounted on the conveyor driving shaft 64, and operably connected to the conveyor driving shaft 64 when the conveyor driving shaft 64 rotates in the direction opposite to one direction, thereby receiving the power from the conveyor driving shaft 64. The second one-way power transmission member 68 may freely rotate while not being operably connected to the conveyor driving shaft 64 when the conveyor driving shaft 64 rotates in the one direction.

The first and second rack portions 70 and 72 may be fixedly mounted on the delivery unit 30 and move in the length direction L together with the delivery unit 30. The first and second rack portions 70 and 72 may respectively be engaged with the first and second one-way power transmission members 66 and 68 to thus receive the power from the first and second one-way power transmission members 66 and 68, thereby moving in the length direction L.

As an example, the first rack portion 70 may be directly or indirectly connected to one of the pair of first support plates 44 and engaged with the first one-way power transmission member 66. When the conveyor driving shaft 64 rotates in the one direction, the first one-way power transmission member 66 may be operably connected to the conveyor driving shaft 64 to thus receive the power from the conveyor driving shaft 64, and the first rack portion 70 may receive the power from the first one-way power transmission member 66, thereby moving to the other side in the length direction L. Accordingly, when the conveyor driving shaft 64 rotates in the one direction, the delivery unit 30 may move to the other side in the length direction L to implement the deployed state. The second rack portion 72 may be directly or indirectly connected to one of the pair of second support plates 46 and engaged with the second one-way power transmission member 68. When the conveyor driving shaft 64 rotates in the direction opposite to the one direction, the second one-way power transmission member 68 may be operably connected to the conveyor driving shaft 64 to thus receive the power from the conveyor driving shaft 64, and the second rack portion 72 may receive the power from the second one-way power transmission member 68, thereby moving to the one side in the length direction L. Accordingly, when the conveyor driving shaft 64 rotates in the direction opposite to the one direction, the delivery unit 30 may move to the one side in the length direction L to implement the retracted state. In this specification, the first or second one-way power transmission member 66 or 68 and the first or second rack portion 70 or 72 are exemplified as a rack and a pinion gear coupled to each other, and types of the first and second one-way power transmission member 66 and 68 and the first and second rack portion 70 and 72 may not be necessarily limited thereto. For example, the first or second one-way power transmission member 66 or 68 and the first or second rack portion 70 or 72 may be a gear and a friction wheel that may be in contact or coupled to each other to transmit power. Alternatively, at least one of the first and second one-way power transmission members 66 and 68 may be a clutch capable of direction control, such as a solenoid. In such example, the second one-way power transmission member and the second rack portion may not be used.

As another example, the first rack portion 70 may be directly or indirectly connected to one of the first and second support plates 44 and engaged with the first one-way power transmission member 66. When the conveyor driving shaft 64 rotates in the one direction, the first one-way power transmission member 66 may be operably connected to the conveyor driving shaft 64 to thus receive the power from the conveyor driving shaft 64, and the first rack portion 70 may receive the power from the first one-way power transmission member 66 to thus move to the other side in the length direction L. Accordingly, when the conveyor driving shaft 64 rotates in the one direction, the delivery unit 30 may move to the other side in the length direction L to implement the deployed state. The second rack portion 72 may be directly or indirectly connected to one of the first and second support plates 46 and engaged with the second one-way power transmission member 68. When the conveyor driving shaft 64 rotates in the direction opposite to the one direction, the second one-way power transmission member 68 may be operably connected to the conveyor driving shaft 64 to thus receive the power from the conveyor driving shaft 64, and the second rack portion 72 may receive the power from the second one-way power transmission member 68 to thus move to the one side in the length direction L. Accordingly, when the conveyor driving shaft 64 rotates in the direction opposite to the one direction, the delivery unit 30 may move to the one side in the length direction L to implement the retracted state.

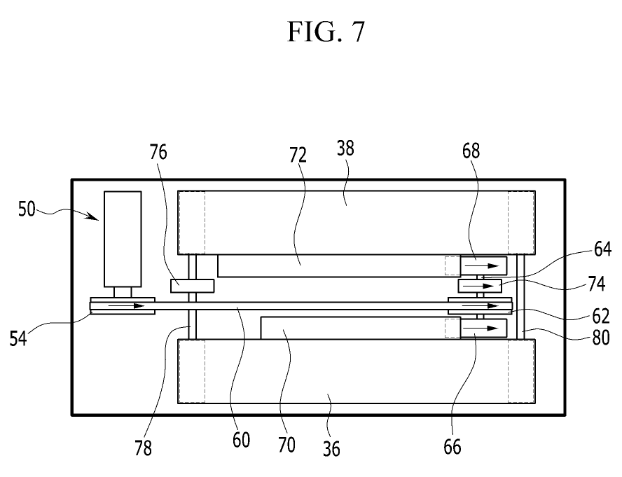

A length of the first rack portion 70 may be shorter than a length of the second rack portion 72 (see FIGS. 7 to 9). When the conveyor driving shaft 64 rotates in the one direction and the delivery unit 30 moves to the other side in the length direction L toward a target delivery point, the first rack portion 70 and the first one-way power transmission member 66 may be released from each other, while the second rack portion 72 may maintain the coupling with the second one-way power transmission member 68. In such state, the first rack portion 70 and the first one-way power transmission member 66 may be released from each other, and accordingly, the delivery unit 30 may no longer move to the other side in the length direction L. However, the coupling of the second rack portion 72 and the second one-way power transmission member 68 may be maintained. Accordingly, when the conveyor driving shaft 64 starts to rotate in the direction opposite to the one direction, the delivery unit 30 may be retracted by moving to the one side in the length direction L.

The conveyor belt driving unit 74 may be fixedly mounted on the conveyor driving shaft 64 and may rotate together with the conveyor driving shaft 64. Accordingly, when the power of the power source 50 is transmitted to the conveyor rotary portion 62 through the power source driving unit 54 and the power source output transmission member 60, the conveyor rotary portion 62, the conveyor driving shaft 64, and the conveyor belt driving unit 74 may rotate together.

The conveyor belt driven unit 76 may be fixedly mounted on a conveyor driven shaft 78 and may rotate together with the conveyor driven shaft 78. The conveyor belt driven unit 76 may be selectively coupled to the conveyor belt driving unit 74 and rotate by selectively receiving the power from the conveyor belt driving unit 74 depending on whether the first rack portion 70 and the first one-way power transmission member 66 are coupled to each other. For example, the conveyor belt driving unit 74 and the conveyor belt driven unit 76 may be gears or friction wheels that may be in contact or coupled to each other to transmit power. In such example, the conveyor belt driven unit 76 and the conveyor belt driving unit 74 may be operably connected using a separate power transmission unit therebetween such that the conveyor belt driven unit 76 may also rotate in the one direction when the conveyor belt driving unit 74 rotates in the one direction. In more detail, when the conveyor driving shaft 64 rotates in the one direction and the first rack portion 70 moves to the other side in the length direction L to thus be separated from the first one-way power transmission member 66, the conveyor belt driven unit 76 may be coupled to the conveyor belt driving unit 74 to thus receive the power from the conveyor belt driving unit 74, thereby rotating in the one direction. Accordingly, the conveyor belt (e.g., the first and second conveyor belts 36 and 38) may also rotate in the one direction, and the consignment on the conveyor belt (e.g., the first and second conveyor belts 36 and 38) may thus move to the other side in the length direction L toward the target delivery point. In such state, although the second rack portion 72 maintains the coupling with the second one-way power transmission member 68, the conveyor driving shaft 64 may rotate in the one direction, thus preventing the power from being transmitted to the second one-way power transmission member 68 and the second rack portion 72. In contrast, when the conveyor driving shaft 64 starts to rotate in the opposite direction, the second rack portion 72 may be operably coupled to the second one-way power transmission member 68, and the second rack portion 72 may thus start to move to the one side in the length direction L. In such state, the first rack portion 70 may move to the one side in the length direction L together with the second rack portion 72 to be coupled again to the first one-way power transmission member 66, and the conveyor belt driven unit 76 may be separated from the conveyor belt driving unit 74. Accordingly, the conveyor belt driven unit 76 and the conveyor belt (including the first and second conveyor belts 36 and 38) may not rotate due to not receiving the power from the conveyor belt driving unit 74.

As an example, the conveyor driven shaft 78 may be fixedly mounted on one of the plurality of first support rollers 32 and one of the plurality of second support rollers 34 (typically, the first and second support rollers 32 and 34 at the one farthest side in the length direction L) to thus transmit the power to the plurality of first and second support rollers 32 and 34. Accordingly, the plurality of first and second support rollers 32 and 34 and the first and second conveyor belts 36 and 38 may receive the power to rotate in the one direction or the direction opposite thereto. An auxiliary rotary shaft 80 may be fixedly mounted on each of the first and second support rollers 32 and 34 at the other farthest side in the length direction L, and the first and second support rollers 32 and 34 at the other farthest side in the length direction L and the auxiliary rotary shaft 80 may thus rotate together. As another example, the conveyor driven shaft 78 may be fixedly mounted on one of the plurality of support rollers and transmit the power to the plurality of support rollers. Accordingly, the plurality of support rollers and the conveyor belt may receive the power to rotate in the one direction or the direction opposite thereto. The auxiliary rotary shaft 80 may be fixedly mounted on the support roller at the other farthest side in the length direction L, and the support roller at the other farthest side in the length direction L and the auxiliary rotary shaft 80 may thus rotate together. As a result, the conveyor belt (including the first and second conveyor belts 36 and 38) may rotate in the one direction or the direction opposite thereto by rotating the conveyor driving shaft 64 and the auxiliary rotary shaft 80.

The driving unit may further include first and second auxiliary rotary portions 56 and 58. The first and second auxiliary rotary portions 56 and 58 may be connected to the power source output transmission member 60 to facilitate the power transmission through the power source output transmission member 60, or to adjust the rotation direction of the conveyor rotary portion 62, the conveyor driving shaft 64, the first and second one-way power transmission members 66 and 68, the conveyor belt driving unit 74, the conveyor belt driven unit 76, and the conveyor driven shaft 78 based on the rotation direction of the power source driving unit 54. However, whether the auxiliary rotary portion is used, a position of the auxiliary rotary portion, and the number of auxiliary rotary portions are not necessarily limited to those exemplified, and a designer may appropriately set whether the auxiliary rotary portion is used, the position of the auxiliary rotary portion, and the number of auxiliary rotary portions based on the required specification and the required power of the delivery apparatus 10.

Hereinafter, the description describes an operation of the apparatus 10 of delivering the consignment according to an embodiment of the present disclosure.

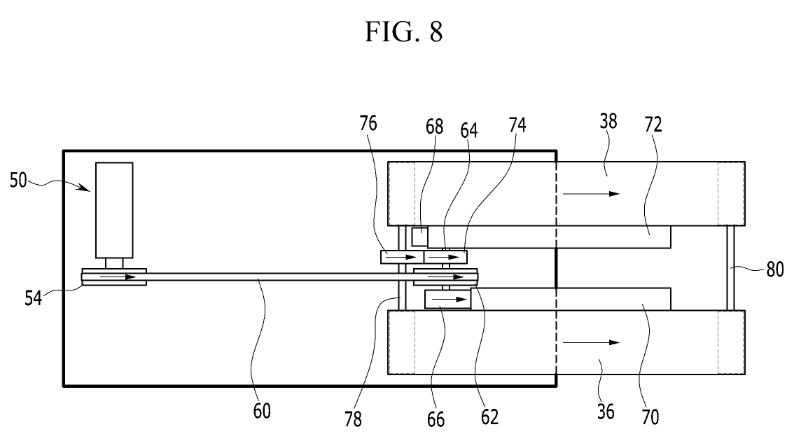

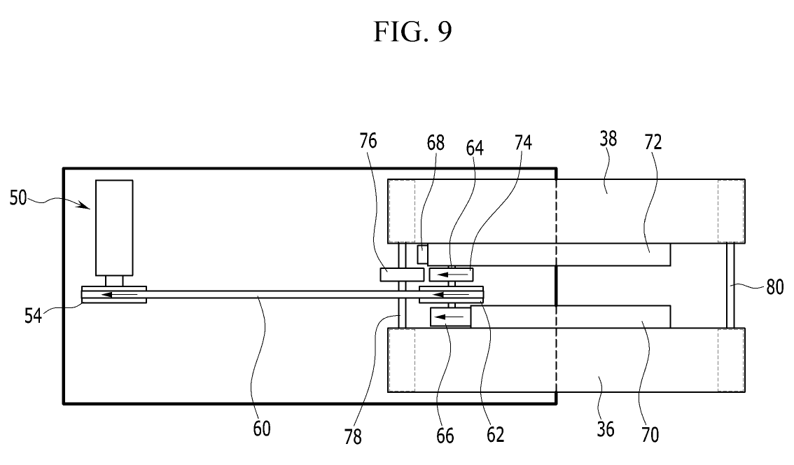

FIG. 7 schematically shows a state in which the apparatus of delivering the consignment according to an embodiment of the present disclosure starts delivering the consignment. FIG. 8 schematically shows a state in which the first and second conveyor belts of the apparatus of delivering the consignment according to an embodiment of the present disclosure rotate and deliver the consignment. FIG. 9 schematically shows a state in which the apparatus of delivering the consignment according to an embodiment of the present disclosure starts the retraction.

As shown in FIG. 7, when the delivery apparatus 10 starts delivering the consignment, the power source 50 may rotate the power source shaft 52, and the power source driving unit 54 fixedly mounted on the power source shaft 52 may rotate the conveyor driving shaft 64 in the one direction through the power source output transmission member 60 and the conveyor rotary portion 62. In such state, the first one-way power transmission member 66 may be operably connected to the conveyor driving shaft 64 and coupled to the first rack portion 70, and the first rack portion 70 may thus move to the other side in the length direction L. In such state, the conveyor belt driven unit 76 may be spaced and released from the conveyor belt driving unit 74. Accordingly, although the delivery unit 30 moves to the other side in the length direction L toward the target delivery point, the first and second conveyor belts 36 and 38 may not rotate. The conveyor driving shaft 64 may rotate in the one direction, and accordingly, the second one-way power transmission member 68 may not be operably connected to the conveyor driving shaft 64. However, the delivery unit 30 may move to the other side in the length direction L and the second one-way power transmission member 68 may be coupled to the second rack portion 72, and the second one-way power transmission member 68 may thus also rotate in the one direction.

As shown in FIG. 8, when the power source 50 continuously rotate the conveyor driving shaft 64 in the one direction, the delivery unit 30 may move to the other side in the length direction L toward the target delivery point, and the first one-way power transmission member 66 may be separated from the first rack portion 70, whereas the second one-way power transmission member 68 may continuously maintain the coupling with the second rack portion 72. The first one-way power transmission member 66 may be separated from the first rack portion 70, and the movement of the delivery unit 30 to the other side in the length direction L may thus be stopped, whereas the conveyor belt driven unit 76 may receive the power by being operably coupled to the conveyor belt driving unit 74. Accordingly, the conveyor belt driven unit 76, the conveyor driven shaft 78, and the first and second conveyor belts 36 and 38 may rotate in the one direction, and the top portions of the first and second conveyor belts 36 and 38 may move to the other side in the length direction L. Accordingly, the consignment disposed on the top portions of the first and second conveyor belts 36 and 38 may move to the other side in the length direction L together with the top portions of the first and second conveyor belts 36 and 38 and thus be disposed at the target delivery point. When the power source 50 continuously rotates the conveyor driving shaft 64 in the one direction, all the consignments may be delivered to the target delivery point and the first and second conveyor belts 36 and 38 may continuously rotate in the one direction.

When the movement of the delivery unit 30 to the other side in the length direction L stops, the rotation of the second one-way power transmission member 68 and the movement of the second rack portion 72 may also stop.

As shown in FIG. 9, when the delivery of the consignment is completed, the delivery apparatus 10 may retract the delivery unit 30. That is, the power source 50 may rotate the conveyor driving shaft 64 in the direction opposite to the one direction by using the power source shaft 52, the power source driving unit 54, the power source output transmission member 60, and the conveyor rotary portion 62. In such state, the second one-way power transmission member 68 may be operably connected to the conveyor driving shaft 64 and coupled to the second rack portion 72, and the second rack portion 72 may thus move to the one side in the length direction L. Accordingly, the conveyor belt driving unit 74 and the conveyor belt driven unit 76 may be released from each other. Accordingly, although the delivery unit 30 moves to the one side in the length direction L toward the retracted position, the first and second conveyor belts 36 and 38 may not rotate. The conveyor driving shaft 64 may rotate in the direction opposite to the one direction, and accordingly, the first one-way power transmission member 66 may not be operably connected to the conveyor driving shaft 64. However, the delivery unit 30 may move to the one side in the length direction L and the first one-way power transmission member 66 may be coupled to the first rack portion 70. Accordingly, the first one-way power transmission member 66 may also rotate in the direction opposite to the one direction.

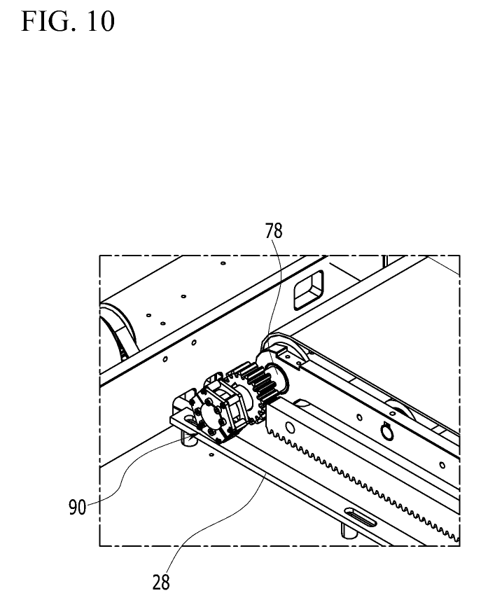

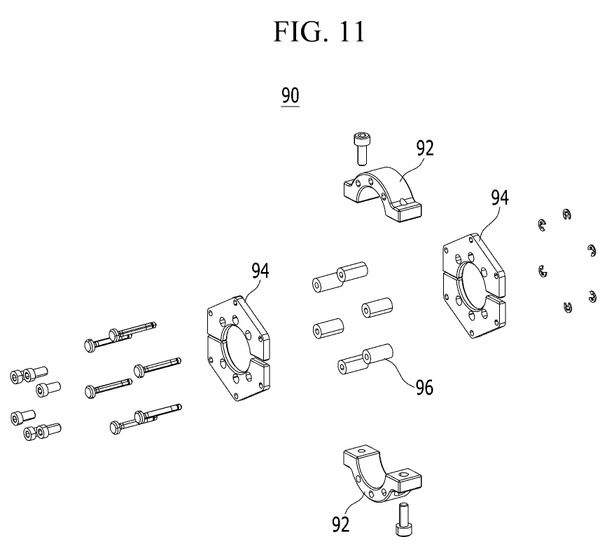

FIG. 10 is a schematic view showing a brake device of the apparatus of delivering the consignment according to an embodiment of the present disclosure. FIG. 11 is an exploded view of the brake device of the apparatus of delivering the consignment according to an embodiment of the present disclosure.

As shown in FIGS. 10 and 11, the delivery apparatus 10 according to an embodiment of the present disclosure may further include a brake rail 28 and a brake device 90.

The brake rail 28 may be mounted on the base 14 and may extend in the length direction L. The brake rail 28 may at least extend in the length direction L from a position in the length direction L of the conveyor driven shaft 78 in the retracted state to a position in the length direction L of the conveyor driven shaft 78 in the deployed state. Accordingly, the brake device 90 can be fixedly mounted on the conveyor driven shaft 78 and may slide along the brake rail 28 to thus move in the length direction L. However, in some example embodiments, the brake rail 28 may not be provided and the brake device 90 may slide on the base 14.

The brake device 90 may be fixedly mounted on the conveyor driven shaft 78 and configured to be movable along the brake rail 28 together with the conveyor driven shaft 78 in the length direction L, and to prevent the rotation of the conveyor driven shaft 78 caused by a load of the consignment, i.e., the rotation of the first and second conveyor belts 36 and 38. The brake device 90 may include a plurality of shaft holders 92, a pair of pin holders 94, and at least one pin 96.

The plurality of shaft holders 92 may surround an outer peripheral surface of the conveyor driven shaft 78 and coupled to each other to thus fixedly mount the brake device 90 on the conveyor driven shaft 78. As an example, FIG. 11 shows that two shaft holders 92 are provided, and the number of shaft holders 92 is not necessarily limited thereto.

The pair of pin holders 94 may respectively be coupled to both surfaces of the plurality of shaft holders 92 by using coupling members such as screws, bolts, or nuts. Each pin holder 94 may have a size larger than a size of the shaft holders 92 in a coupled state, and each pin holder 94 may have a polygonal plate shape. Accordingly, a plurality of sides of each pin holder 94 may act as a resistance for preventing the rotation of the brake device 90

In more detail, the size of the pin holder 94 may be larger than the size of the shaft holders 92 in the coupled state, and one of the sides of the pin holder 94 may be in contact with the brake rail 28 or face the brake rail 28 in the retracted state of the delivery apparatus 10. Accordingly, the brake device 90 may be stationary and does not rotate. When the delivery apparatus 10 is mounted on the vehicle while being tilted downward, a force for rotating the first and second conveyor belts 36 and 38 may be applied to the first and second conveyor belts 36 and 38 due to a load of the consignment disposed on the first conveyor belt 36 and/or the second conveyor belt 38. However, the force may be insufficient to rotate the side of the pin holder 94 in contact with or facing the brake rail 28. Accordingly, the pair of pin holders 94 having the polygonal shape may prevent the rotation of the brake device 90 caused by the load of the consignment.

When the power from the power source 50 is transmitted to the conveyor driven shaft 78 through the conveyor belt driving unit 74 and the conveyor belt driven unit 76, which are coupled to each other, the power from the power source 50 may overcome the resistance caused by the side of the pin holder 94 and rotate the conveyor driven shaft 78 and the brake device 90. Accordingly, the first and second conveyor belts 36 and 38 may rotate and the consignment may thus be delivered to the target delivery point.

Here, each pin holder 94 is exemplified as having a hexagonal plate shape, and a shape of each pin holders 94 may not be necessarily limited thereto. The pin holder 94 may have any polygonal shape that prevents the rotation of the brake device 90 caused by the load of the consignment while being rotatable by the power from the power source 50.

At least one pin 96 may be rotatably mounted at each vertex of the pair of pin holders 94. If the pin holder 94 has the hexagonal shape, six pins 96 may be mounted at six vertices of the pin holder 94, respectively. If one side of the pin holder 94 faces the brake rail 28, the corresponding side may not be in contact with the brake rail 28, and two pins 96 mounted at both the vertices of the side may be in contact with the brake rail 28. In this state, when the delivery unit 30 moves in the length direction L, the two pins 96 in contact with the brake rail 28 may rotate, thereby facilitating the movement of the delivery unit 30. The at least one pin 96 may be a selective component, and one side of the pin holder 94 may be in contact with the brake rail 28 and slide along the brake rail 28.

Although the specific example embodiments of the present disclosure have been described hereinabove, the scopes of the present disclosure are not necessarily limited thereto and can include modifications and equivalents that may be easily made or recognized by those skilled in the art to which the present disclosure pertains.

What is claimed is:

1. An apparatus of delivering a consignment, comprising:
a housing having a mounting space by having a length from a first length side to a second length side in a length direction, and a width from a first width side to a second width side in a width direction perpendicular to the length direction, at least a portion of the second length side of the housing being open in the length direction;
a delivery unit mounted in the housing to be movable in the length direction between a retracted state and a deployed state, and wherein the delivery unit comprises:
support rollers disposed to be rotatable about the width direction, and
a conveyor belt extending across the support rollers and rotatable between the support rollers at both the first length side and the second length side in the length direction by rotation of at least one of the support rollers; and
a driving unit configured to provide a power to the delivery unit to move the delivery unit in the length direction between the retracted state and the deployed state, and to provide the power to at least one of the support rollers to rotate the at least one support roller,
wherein the apparatus is configured such that the consignment can be disposed on the conveyor belt and delivered to a target delivery point by rotation of the conveyor belt in a first rotation direction.

2. The apparatus of claim 1, further comprising first and second rails mounted on both the first width side and the second width side of the housing, wherein the first and second rails extend in the length direction; and
wherein the delivery unit further comprises:
first and second support plates disposed on both the first width side and the second width side of the delivery unit,
a first guide disposed on a first outer surface of the first support plate facing the first rail and having a first groove corresponding to the first rail, and
a second guide disposed on a second outer surface of the second support plate facing the second rail and having a second groove corresponding to the second rail, the first rail being coupled to the first groove of the first guide to be movable in the length direction, and the second rail being coupled to the second groove of the second guide to be movable in the length direction.

3. The apparatus of claim 2, wherein the support rollers are rotatably connected to the first and second support plates.

4. The apparatus of claim 2, wherein the driving unit comprises:
a power source including a power source shaft rotatable in both power-source-shaft rotation directions and configured to provide the power;
a power source driving unit configured to provide the power by being fixedly mounted on and rotatable together with the power source shaft;
a power source output transmission member;
a conveyor driving shaft;
a conveyor rotary portion operably connected to the power source driving unit through the power source output transmission member and fixedly mounted on the conveyor driving shaft;
a first one-way power transmission member mounted on the conveyor driving shaft, wherein the first one-way power transmission member is operably connected to the conveyor driving shaft based on the conveyor driving shaft being rotated in the first rotation direction, and wherein the first one-way power transmission member is freely rotatable relative to the conveyor driving shaft based on the conveyor driving shaft being rotated in a second rotation direction opposite to the first rotation direction;
a second one-way power transmission member mounted on the conveyor driving shaft, wherein the second one-way power transmission member is operably connected to the conveyor driving shaft based on the conveyor driving shaft being rotated in the second rotation direction opposite to the first rotation direction, and wherein the second one-way power transmission member is freely rotatable relative to the conveyor driving shaft based on the conveyor driving shaft being rotated in the first rotation direction;
a first rack portion fixedly mounted on the delivery unit and engaged with the first one-way power transmission member in a first configuration to receive the power from the first one-way power transmission member and move to the second length side in the length direction based on the conveyor driving shaft being rotated in the first rotation direction; and
a second rack portion fixedly mounted on the delivery unit and engaged with the second one-way power transmission member in a second configuration to receive the power from the second one-way power transmission member and move to the first length side in the length direction based on the conveyor driving shaft being rotated in the second rotation direction opposite to the first rotation direction.

5. The apparatus of claim 4, wherein a first-rack-portion length of the first rack portion is shorter than a second-rack-portion length of the second rack portion.

6. The apparatus of claim 4, wherein the driving unit further comprises:
a conveyor belt driving unit fixedly mounted on the conveyor driving shaft and rotatable together with the conveyor driving shaft; and
a conveyor belt driven unit fixedly mounted on a conveyor driven shaft and rotatable together with the conveyor driven shaft, and wherein the conveyor belt driven unit is selectively coupled to the conveyor belt driving unit depending on whether the first rack portion and the first one-way power transmission member are coupled to each other.

7. The apparatus of claim 6, wherein, based on the first rack portion moving to the second length side in the length direction and being separated from the first one-way power transmission member, the conveyor belt driven unit is coupled to the conveyor belt driving unit.

8. The apparatus of claim 7, wherein, based on the conveyor driving shaft being rotated in the first rotation direction and the first rack portion being separated from the first one-way power transmission member, the conveyor belt driven unit is operably connected to the conveyor belt driving unit to rotate in the first rotation direction.

9. The apparatus of claim 6, wherein the conveyor driven shaft is fixedly mounted on one of the support rollers.

10. The apparatus of claim 6, further comprising a brake device fixedly mounted on the conveyor driven shaft and configured to prevent rotation of the conveyor driven shaft caused by a load of the consignment and to be rotatable by the power from the power source.

11. The apparatus of claim 1, wherein the support rollers includes first support rollers and second support rollers, and wherein the conveyor belt includes a first conveyor belt extending across the first support rollers and a second conveyor belt extending across the second support rollers;
wherein first and second rails are mounted on both sides of the housing in the width direction and extend in the length direction; and
wherein the delivery unit further comprises:
a first pair of first support plates disposed on the first width side and a center portion in the width direction and extending in the length direction,
a second pair of second support plates disposed on the second width side and the center portion in the width direction and extending in the length direction,
a first guide disposed on a first outer surface of one of the first pair of the first support plates facing the first rail and having a first groove corresponding to the first rail, and
a second guide disposed on a second outer surface of one of the second pair of the second support plates facing the second rail and having a second groove corresponding to the second rail, wherein the first rail is coupled to the first groove of the first guide to be movable in the length direction, and the second rail is coupled to the second groove of the second guide to be movable in the length direction.

12. The apparatus of claim 11, wherein the first support rollers are rotatably connected to the first pair of the first support plates, and the second support rollers are rotatably connected to the second pair of the second support plates.

13. The apparatus of claim 11, wherein the driving unit comprises:
a power source including a power source shaft rotatable in both power-source-shaft rotation directions and configured to provide the power;
a power source driving unit configured to provide the power by being fixedly mounted on and rotatable together with the power source shaft;
a power source output transmission member;
a conveyor driving shaft;
a conveyor rotary portion operably connected to the power source driving unit through the power source output transmission member and fixedly mounted on the conveyor driving shaft;
a first one-way power transmission member mounted on the conveyor driving shaft, wherein the first one-way power transmission member is operably connected to the conveyor driving shaft based on the conveyor driving shaft being rotated in the first rotation direction, and wherein the first one-way power transmission member is freely rotatable relative to the conveyor driving shaft based on the conveyor driving shaft being rotated in a second rotation direction opposite to the first rotation direction;
a second one-way power transmission member mounted on the conveyor driving shaft, wherein the second one-way power transmission member is operably connected to the conveyor driving shaft based on the conveyor driving shaft being rotated in the second rotation direction opposite to the first rotation direction, and wherein the second one-way power transmission member is freely rotatable relative to the conveyor driving shaft based on the conveyor driving shaft being rotated in the first rotation direction;
a first rack portion fixedly mounted on the delivery unit and engaged with the first one-way power transmission member in a first configuration to receive the power from the first one-way power transmission member and move to the second length side in the length direction based on the conveyor driving shaft being rotated in the first rotation direction; and
a second rack portion fixedly mounted on the delivery unit and engaged with the second one-way power transmission member in a second configuration to receive the power from the second one-way power transmission member and move to the first length side in the length direction based on the conveyor driving shaft being rotated in the second rotation direction opposite to the first rotation direction.

14. The apparatus of claim 13, wherein a first-rack-portion length of the first rack portion is shorter than a second-rack-portion length of the second rack portion.

15. The apparatus of claim 13, wherein the driving unit further comprises:
a conveyor belt driving unit fixedly mounted on the conveyor driving shaft and rotatable together with the conveyor driving shaft, and
a conveyor belt driven unit fixedly mounted on a conveyor driven shaft and rotatable together with the conveyor driven shaft, wherein the conveyor belt driven unit is selectively coupled to the conveyor belt driving unit depending on whether the first rack portion and the first one-way power transmission member are coupled to each other.

16. The apparatus of claim 15, wherein, based on the first rack portion being moved to the second length side in the length direction and being separated from the first one-way power transmission member, the conveyor belt driven unit is coupled to the conveyor belt driving unit.

17. The apparatus of claim 16, wherein, based on the conveyor driving shaft being rotated in the first rotation direction and the first rack portion being separated from the first one-way power transmission member, the conveyor belt driven unit is operably connected to the conveyor belt driving unit to rotate in the first rotation direction.

18. The apparatus of claim 15, wherein the conveyor driven shaft is fixedly mounted on one of the first support rollers and one of the second support rollers.

19. The apparatus of claim 15, further comprising a brake device fixedly mounted on the conveyor driven shaft and configured to prevent rotation of the conveyor driven shaft caused by a load of the consignment and to be rotatable by the power from the power source.

20. The apparatus of claim 19, wherein the brake device comprises:
shaft holders surrounding an outer peripheral surface of the conveyor driven shaft and coupled to each other to fixedly mount the brake device on the conveyor driven shaft, and
a pair of pin holders respectively coupled to both surfaces of the shaft holders, each having a first radial size larger than a second radial size of the shaft holders in a coupled state, and each having a polygonal shape.
